(19) United States
(12) Patent Application Publication
(10) Pub. No.: US 2009/0185380 A1
(43) Pub. Date: Jul. 23, 2009

(54) LED Lamp with Heat Dissipating Configuration

(76) Inventor: Sung Tao HO, Zhonghe City (TW)

Correspondence Address: HDLS Patent & Trademark Services, P.O. BOX 220746, CHANTILLY, VA, 20153-0746, US

(21) Appl. No.: 12/015,564

(22) Filed: Jan. 17, 2008

(51) Int. Cl. F21V 29/00

(52) U.S. Cl. 362/294

(57) ABSTRACT

A LED lamp with heat dissipating configuration includes a lamp body and a front cover, the lamp body includes a plurality of perforations, and each perforation is arranged along an axis of the lamp body, and the front cover includes a lamp base and a plurality of slots connecting to one edge of the lamp body.

### BACKGROUND

Due to its lightness, electricity loss or use life being superior to a traditional lamp or other light emitting device such as mercury lamp, an LED is used widely to replace the traditional light emitting device. However, a lot of heat will be generated which can lead to light attenuation or reducing use life of the LED body. So how to realize dispersing heat of the LED effectively is essential to its using extension at present.

A heat dissipating device, as we known, includes a set of heat sink fins with same shape and equidistance arranged on the LED body. Heats are transmitted by the heat sink fins and dispersed by cross-ventilation. However, this configuration leads to a disadvantage of huge volume and setting complicated. The shape and mechanical intensity can not match the role of exterior material. If putting the heat dissipating device into the inner airproof space of the lamp, it would be useless for heat dissipating because of isolated to air. Moreover, the efficiency of heat dissipating is directly proportional to its area, that to say, it needs more area to disperse heat effectively. But it is so hard to design more dissipating area according to the present configuration which leads to effect heat dissipating.

### BRIEF SUMMARY

The present invention is directed to provide an LED lamp with heat dissipating configuration which can extend more area to disperse heat.

According to an embodiment of the present invention, an LED lamp with heat dissipating configuration is provided. The LED lamp with heat dissipating configuration includes a lamp body and a front cover, the lamp body includes a plurality of perforations, and each perforation is arranged along an axis of the lamp body, and the front cover includes a lamp base and a plurality of slots connecting to one edge of the lamp body.

A section of each perforation may be designed various shapes such as polygon.

The shape of a section of each perforation is hexagon.

A plurality of grooves are arranged on the lamp body, and a shape of a section of each groove is gibbous.

Another edge of the lamp body is connected to a rear cover including a plurality of slots.

According to another embodiment of the present invention, an LED lamp with heat dissipating configuration is provided. The LED lamp with heat dissipating configuration includes a lamp body, a front cover and at least a outside cover, the lamp body includes a plurality of perforations, and each perforation is arranged along an axis of the lamp body, and the front cover includes a lamp base and a plurality of slots connecting to one edge of the lamp body, a plurality of strip supports are arranged on the inner surface of the outside cover to withstand the outside of the lamp body.

Each strip support is arranged on the inner surface of the outside cover along its axis and the support is shaped as “Y”, and two edges on the top side of the Y configuration bend to the inner side to form two gibbous strips.

A plurality of lockholes are arranged on the inner side of the outside cover.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic view according to an LED lamp with heat dissipating configuration according to an embodiment of present invention.

FIG. 2 is an exploded, schematic view according to an LED lamp with heat dissipating configuration according to an embodiment of present invention.

FIG. 3 is a section, schematic view according to an LED lamp with heat dissipating configuration according to an embodiment of present invention.

FIG. 4 is another schematic view according to an LED lamp with heat dissipating configuration according to an embodiment of present invention.

FIG. 5 is a schematic, assembly view according to an LED lamp with heat dissipating configuration according to an embodiment of present invention.

FIG. 6 is a section, schematic view of FIG. 5.

FIG. 7 is a schematic, three-dimensional view according to an LED lamp with heat dissipating configuration according to an embodiment of present invention.

FIG. 8 is another section, schematic view according to an LED lamp with heat dissipating configuration according to an embodiment of present invention.

FIG. 9 is a three-dimensional, exploded view according to an LED lamp with heat dissipating configuration according to an embodiment of present invention.

FIG. 10 is a section, schematic view of FIG. 9.

### DETAILED DESCRIPTION

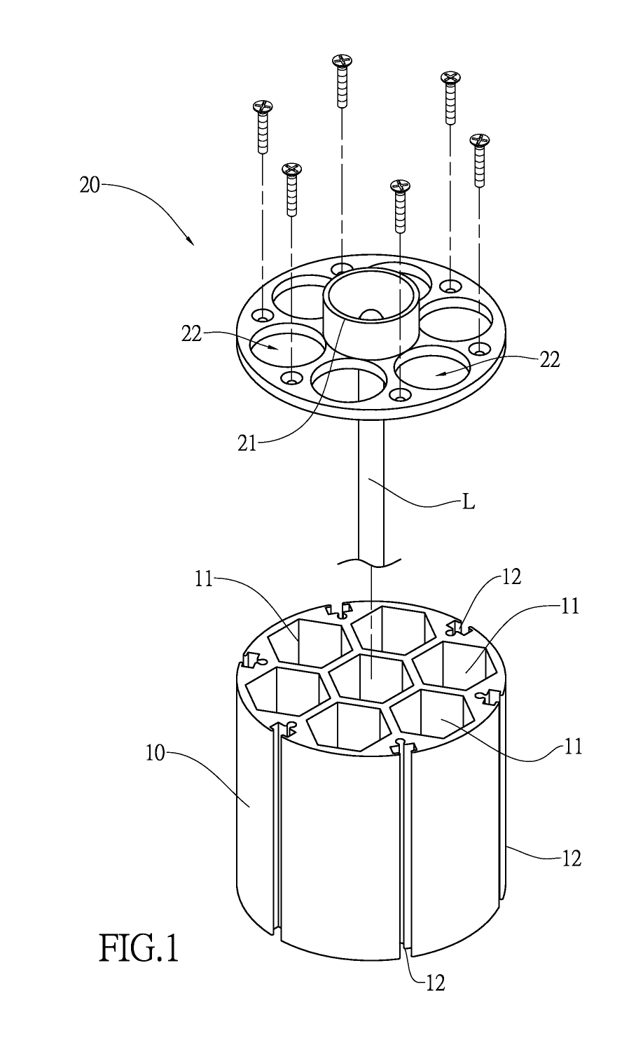

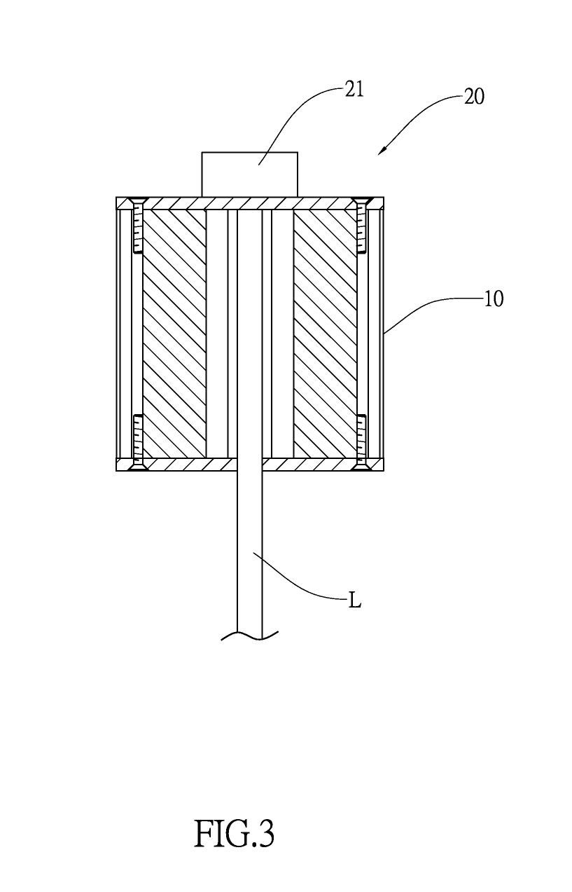

Referring to FIG. 1 to FIG. 3, an LED lamp with heat dissipating configuration according an embodiment of the invent includes a lamp body 10 and a front cover 20. The lamp body 10 includes a plurality of perforations 11, and each perforation 11 is arranged along an axis of the lamp body 10. The front cover 20 includes a lamp base 21 and a plurality of slots 22 and it connects to one edge of the lamp body 10 to transmit heat generated by LED of the lamp base 21 to the lamp body 10. Air enters into the perforations 11 through the slots 22 of the front cover 20 and takes heats out. The perforations 11 come up to extend area exposed to air of the lamp body 10 and they would keep a limit of length. The perforations 11 is arranged along an axis of the lamp body 10, which can make air circulation fluently. Moreover, a section of each perforation 11 may be designed various shapes such as polygon in order to extend area exposed to air. According to this embodiment, the shape of a section of each perforation 11 is hexagon which extends more area to disperse heat from the LED lamp.

Furthermore, a plurality of grooves 12 are arranged on the lamp body 10, and each groove 12 is concave to the outside of lamp body 10 along its axis to match with other slide skid rail or fixing device. A shape of a section of each groove 12 is gibbous to have an effect of support.

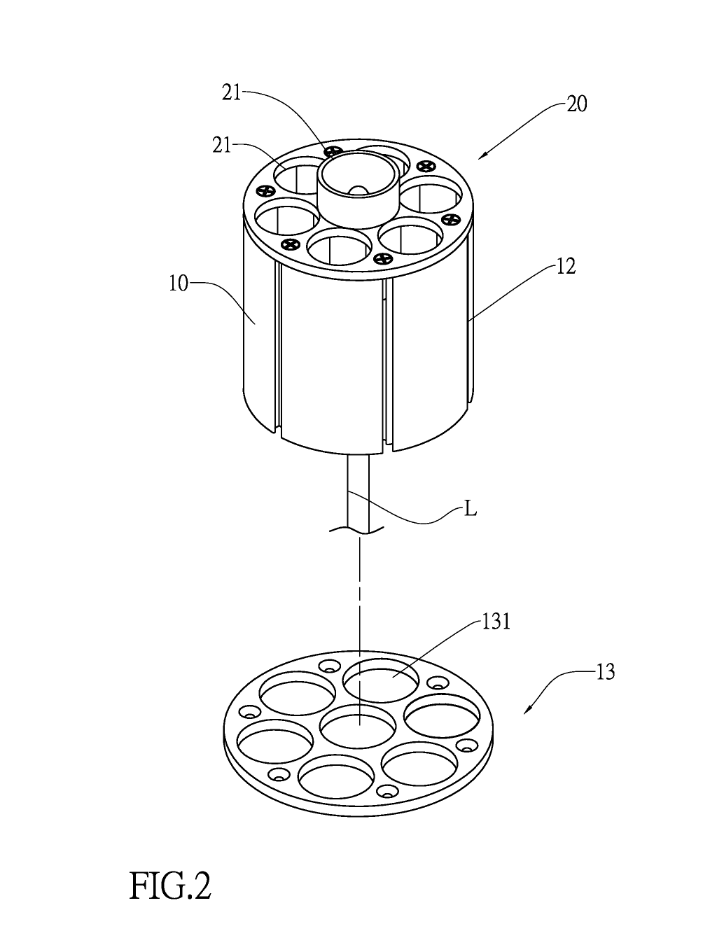

As shown in FIG. 2, another edge of the lamp body 10 is connected to a rear cover 13 including a plurality of slots 131, and the slots 131 are used to disperse heat and help the traction of the material L.

As shown in FIG. 1 to FIG. 3, a quantity of heat generated from the LED on the lamp base 21 is transmitted to the lamp body 10 through the front cover 20, and then to air by the perforations 11 on the outside and inside walls of the lamp body 10. This can disperse heat effectively and avoid pilling up inside.

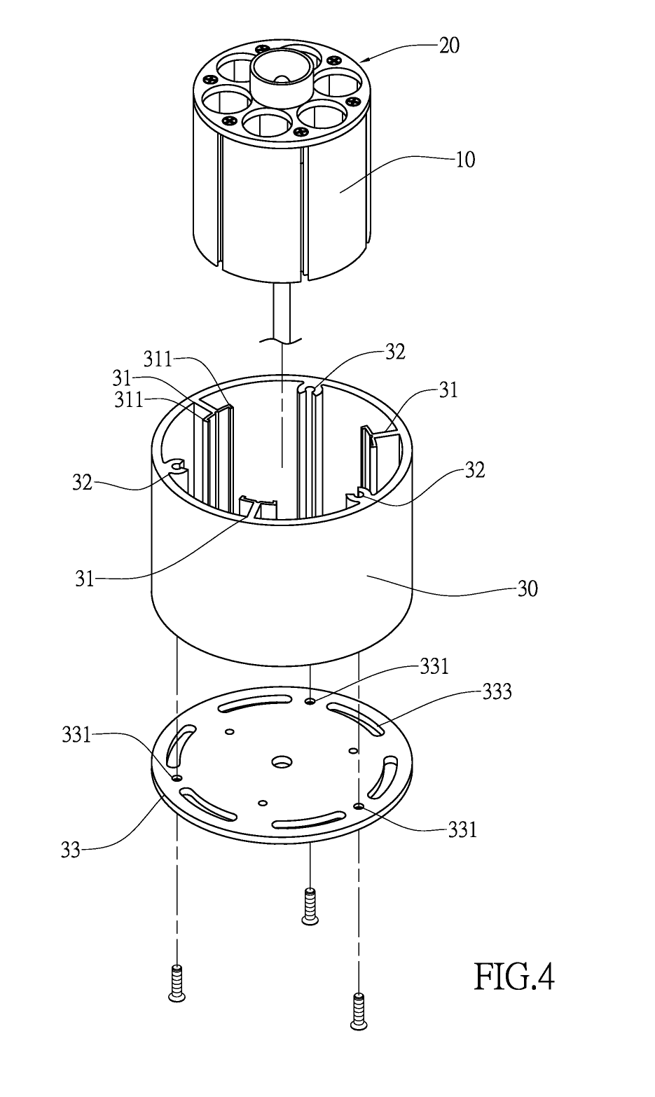

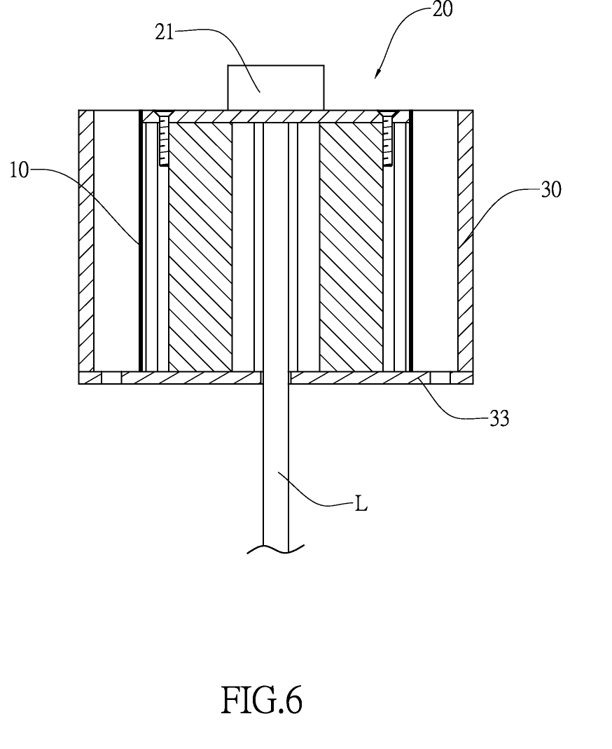

Referring to FIG. 4 to FIG. 6, the LED lamp with heat dissipating configuration further includes an outside cover 30 to adapt to larger space which can extend area of dissipating heat and increase an efficiency of dissipating heat. The outside cover 30 is annular and a plurality of strip supports 31 are arranged on the inner surface of the outside cover 30. When the lamp body 10 is set into the outside cover 30, the strip supports 31 withstand the outside of the lamp body 10 to keep a relative position between the lamp body 10 and the outside cover 30.

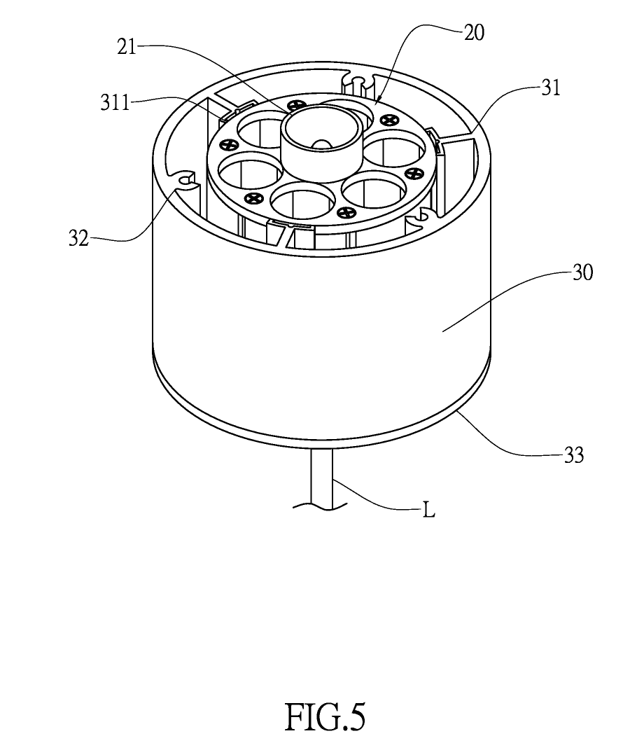

As shown in FIG. 5, each strip support 31 is arranged on the inner surface of the outside cover 30 along its axis and the support 31 is shaped as “Y”. The bottom edge of the support 31 connects to the inner surface of the outside cover 30 and the top edge of the support 31 withstands the outside of the lamp body 10. The central part of the top edge of the Y configuration is bended in order to increase a supporting force to the outside of the lamp body 10. The two edges on the top side of the Y configuration bend to the inner side to form two gibbous strips 311. They can be more flexible when supporting to the lamp body 10, which can increase controlling force to the lamp body 10 and avoid the lamp body 10 sliding.

Moreover, a plurality of lockholes 32 are arranged on the inner side of the outside cover 30 to fix other devices. One edge of the outside cover 30 connects to a cover body 33 to avoid dust or other impurity making damages. The cover body 33 includes at least a cover hole 333 for heat dissipating, or a plurality of holes 331 corresponding to the position of the lockholes 32. The cover body 33 is fixed to the outside cover 30 by inserting or screwing with lock device.

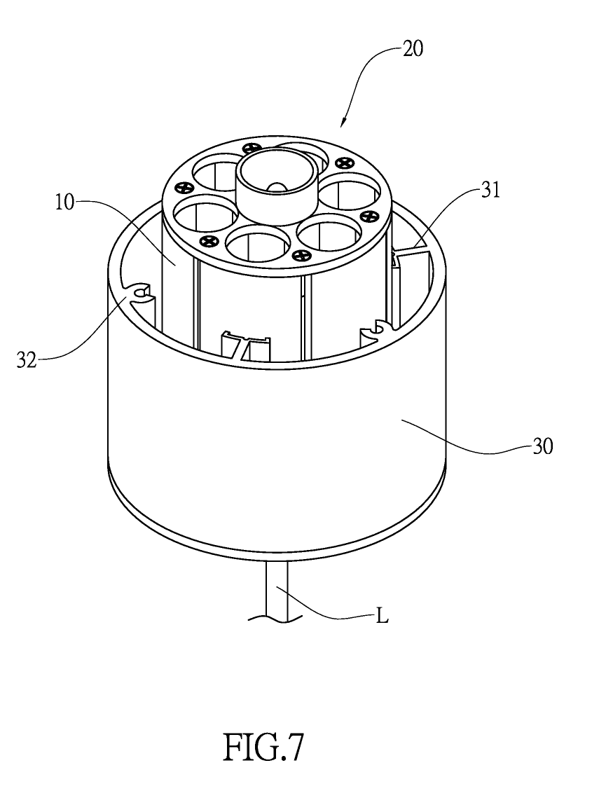

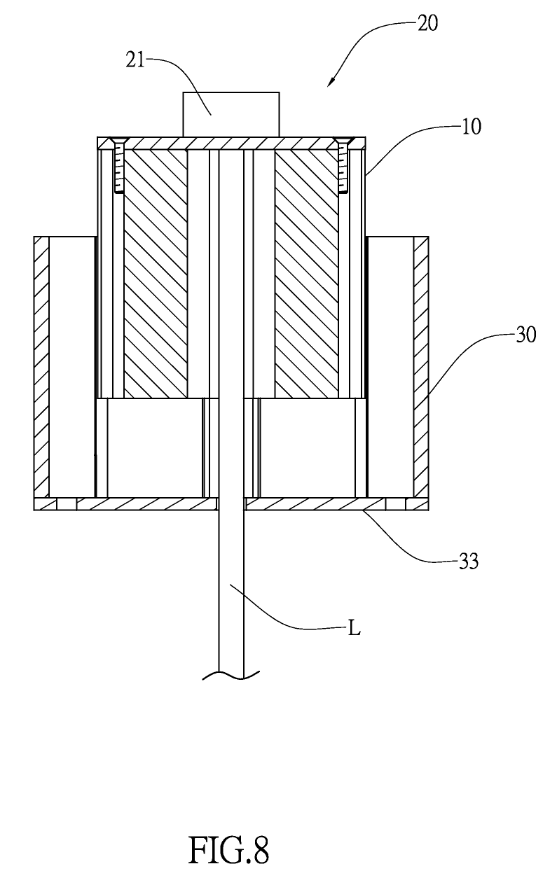

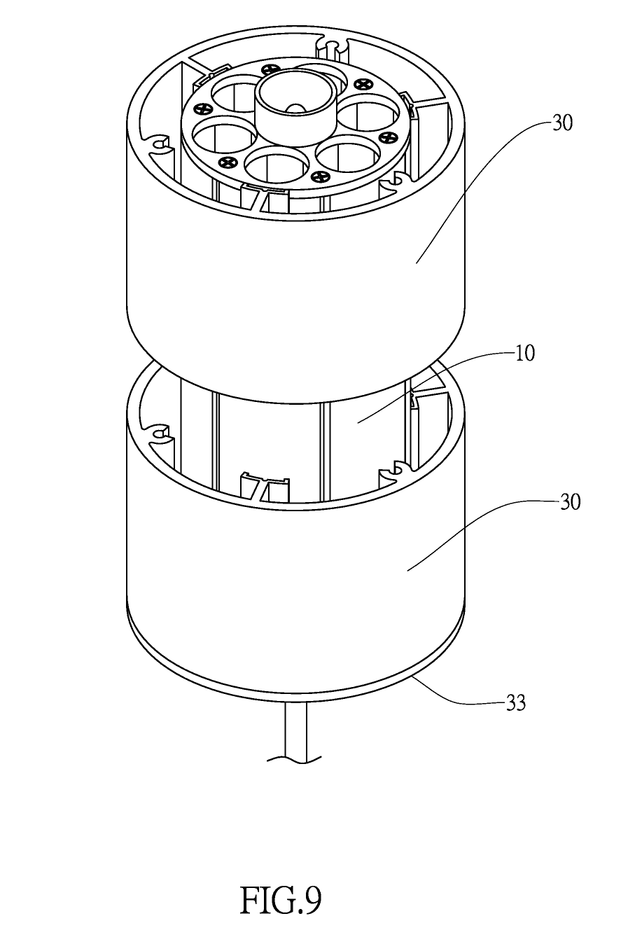

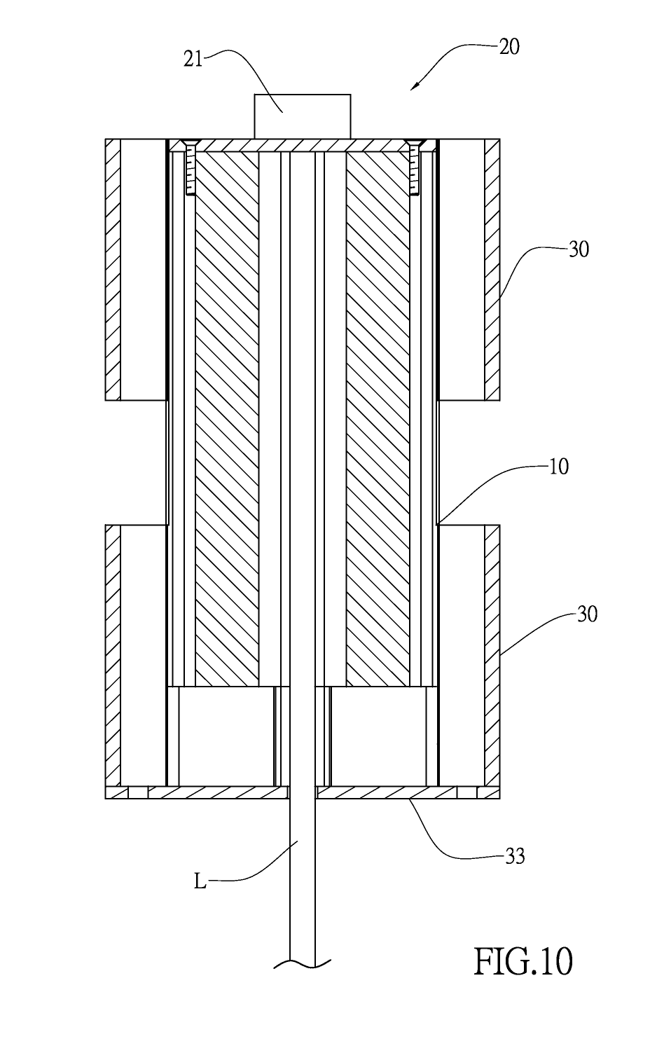

As shown in FIG. 7 and FIG. 8, the lamp body 10 may be arranged on another side of the outside cover 30. Referring to FIG. 9 and FIG. 10, it is available to extend the length of the lamp body 10 and arrange a outside cover 30 respectively on the top and bottom edges of the lamp body 10, which can increase heat dissipating ability especially to huge power LED lamp.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An LED lamp with heat dissipating configuration comprising a lamp body and a front cover, wherein the lamp body comprising a plurality of perforations, and each perforation being arranged along an axis of the lamp body, and the front cover comprising a lamp base and a plurality of slots connecting to one edge of the lamp body.

2. The LED lamp with heat dissipating configuration according to claim 1, wherein a section of each perforation may be designed various shapes such as polygon.

3. The LED lamp with heat dissipating configuration according to claim 2, wherein the shape of a section of each perforation is hexagon.

4. The LED lamp with heat dissipating configuration according to claim 1, wherein a plurality of grooves are arranged on the lamp body and a shape of a section of each groove is gibbous.

5. The LED lamp with heat dissipating configuration according to claim 1, wherein another edge of the lamp body is connected to a rear cover including a plurality of slots.

6. An LED lamp with heat dissipating configuration comprising a lamp body, a front cover and at least a outside cover, wherein the lamp body comprising a plurality of perforations, and each perforation being arranged along an axis of the lamp body, and the front cover comprising a lamp base and a plurality of slots connecting to one edge of the lamp body, a plurality of strip supports being arranged on the inner surface of the outside cover to withstand the outside of the lamp body.

7. The LED lamp with heat dissipating configuration according to claim 6, wherein each strip support is arranged on the inner surface of the outside cover along its axis and the support is shaped as “Y”, and two edges on the top side of the Y configuration bend to the inner side to form two gibbous strips.

8. The LED lamp with heat dissipating configuration according to claim 6, wherein a plurality of lockholes are arranged on the inner side of the outside cover.

9. The LED lamp with heat dissipating configuration according to claim 6, wherein one edge of the outside cover connects to a cover body and the cover body includes at least a cover hole.

10. The LED lamp with heat dissipating configuration according to claim 6, wherein a section of each perforation may be designed various shapes such as polygon.

11. The LED lamp with heat dissipating configuration according to claim 10, wherein the shape of a section of each perforation is hexagon.
